(19) United States
(12) Patent Application Publication
(10) Pub. No.: US 2026/0003826 A1
(43) Pub. Date: Jan. 1, 2026

(54) METHOD, DEVICE, AND PROGRAM FOR PROVIDING INFORMATION REGARDING CONTENT PRODUCTION

(71) Applicant: CJ OliveNetworks Co., Ltd., Seoul (KR)

(72) Inventors: Ye Eun CHUN, Seoul (KR); Se Un PARK, Seoul (KR); Emma Bergqvist, Seoul (KR); Byung Hak KIM, Seoul (KR)

(21) Appl. No.: 19/077,161

(22) Filed: Mar. 12, 2025

(30) Foreign Application Priority Data
Jun. 28, 2024 (KR) 10-2024-0085658

(51) Int. Cl. G06F 16/16; G06F 16/11

(52) U.S. Cl. CPC G06F 16/16; G06F 16/116

(57) ABSTRACT

Herein is proposed a method for providing information regarding content production, comprising: performing preprocessing on a script file; separating and grouping the contents of the preprocessed script file; classifying sentences which meet predetermined condition into one or more categories; storing information related to the grouping of the preprocessed script file or information on the classification of sentences into one or more categories; processing the stored information in response to requests related to the stored information; and displaying the processed information.

### FIELD OF DISCLOSURE

The present disclosure relates to a method, device, and program for providing information regarding content production, and more specifically, for extracting and providing information regarding content production from scripts such as drama scripts.

### CROSS REFERENCE TO RELATED APPLICATIONS

This application claims the priority benefit of Korean Patent Application No. 10-2024-0085658, filed Jun. 28, 2024, the entire content of which is hereby incorporated by reference herein.

### BACKGROUND

Script analysis is an essential step in the video content production process. The traditional approach for script analysis has been for a person to manually read the script and extract the necessary: information. However, this method is time-consuming and labor-intensive, with limitations on the accuracy and consistency of the analysis results.

Recent advancements in AI technology have led to significant progress in the field of natural language processing. However, previous research has faced limitations with regard to text analysis and video production.

The present disclosure aims to address this issue through the development of an AI model specialized in performing script analysis, and through this model, provide a system and method for automatically extracting and analyzing various types of information required for video production.

### DISCLOSURE OF INVENTION

In view of the above, the present disclosure aims to provide a method, device, and program to solve the above-mentioned problems.

Various aspects of the present disclosure aim to:

Provide a method for automatically extracting and structuring information required for content production by analyzing the script format and content;

Analyze and predict various information required for content production, such as relationships between characters, scene characteristics, and production costs, and increase efficiency and reduce content production costs based on the analyzed information.

To this end, the present disclosure proposes a method for providing information on the cost to produce content based on a script, by a system that structures the script and extracts, analyzes, and processes the information therefrom. Furthermore, the present disclosure proposes a method for intuitively displaying structured data to a user through a graphical user interface (GUI) to facilitate modification and analysis tasks.

According to one embodiment of the present disclosure, a method for providing information regarding content production is proposed, comprising: performing preprocessing on a script file; separating and grouping the contents of the preprocessed script file; classifying, for each separated script file, sentences which meet predetermined condition into one or more categories; storing information related to the grouping of the preprocessed script file or information on the classification of sentences into one or more categories; processing the stored information in response to requests related to the stored information; and displaying the processed information.

According to one embodiment of the present disclosure, a device for providing information regarding content production is proposed, comprising: a control unit configured to perform preprocessing on a script file, separate and group the contents of the preprocessed script file, classify, for each separated script file, sentences which meet predetermined condition into one or more categories, and process the stored information in response to requests related to the stored information; a storage unit configured to store information related to the grouping of the preprocessed script file or information on the classification of sentences into one or more categories; and a display unit configured to display the processed information.

According to one embodiment of the present disclosure, a program for providing information regarding content production being stored on a computer-readable storage medium, is proposed, which cause a computer to execute the following operations: performing preprocessing on a script file; separating and grouping the contents of the preprocessed script file; classifying, for each separated script file, sentences which meet predetermined condition into one or more categories; storing information related to the grouping of the preprocessed script file or information on the classification of sentences into one or more categories; processing the stored information in response to requests related to the stored information; and displaying the processed information.

### BRIEF DESCRIPTION OF DRAWINGS

FIG. 1 illustrates a configuration of a device that provides information regarding content production (hereinafter referred to as “information provision device”) according to one embodiment of the present disclosure.

FIG. 2 illustrates a method for processing a script file into a structured format according to one embodiment of the present disclosure.

FIG. 3 illustrates a script structuring process and results screen according to one embodiment of the present disclosure.

FIG. 4 displays a list of characters extracted from a script file according to one embodiment of the present disclosure.

FIG. 5 displays a narration/dialogue classification extracted from a script file according to one embodiment of the present disclosure.

FIG. 6 illustrates a method for extracting and classifying factors related to production costs according to one embodiment of the present disclosure.

FIG. 7 shows an embodiment of a dialogue in a script.

FIG. 8 illustrates an embodiment of the genre chart display.

FIG. 9 illustrates a method by which the information provision device provides content production information according to one embodiment of the present disclosure.

FIG. 10 illustrates a configuration of a system for providing information regarding content production according to one embodiment of the present disclosure.

### DETAILED DESCRIPTION

Hereinafter, some embodiments of the present disclosure will be described in detail with reference to the accompanying drawings. In assigning reference numerals to the components in the drawings, the same components may be assigned the same reference numerals even if they are shown in different drawings. Furthermore, in describing the present embodiments, detailed descriptions of related known configurations or functions may be omitted if it is determined that such descriptions may obscure the gist of the present technical idea. In the present specification, the use of terms such as “comprises,” “has,” “is composed of,” etc., may include other elements unless the term “only” is used. When an element of the present disclosure is expressed in the singular, it may include the plural unless otherwise explicitly stated.

Furthermore, in describing the components of the present disclosure, terms such as “first,” “second,” “A,” “B,” “(a),” “(b),” etc., may be used. These terms are used only to distinguish one component from another and do not limit the essence, order, sequence, or number of the components.

In descriptions of the positional relationships of components, where two or more components are described as being “connected,” “coupled,” or “joined,” it should be understood that two or more components may be “connected,” “coupled,” or “joined” directly, or they may be “connected,” “coupled,” or “joined” with the interposition of one or more other components. Here, the other components may be included in one or more of the two or more components that are “connected,” “coupled,” or “joined” to each other.

In descriptions regarding the temporal sequence or sequential relationships of components, operation methods, manufacturing methods, etc., expressions such as “after,” “following,” “subsequently,” or “before” may encompass non-consecutive cases unless the terms “immediately” or “directly” are explicitly used.

Meanwhile, in cases where a numerical value or corresponding information for a component is mentioned, even if there is no separate explicit description, the numerical value or corresponding information may be interpreted as including a margin of error that may occur due to various factors.

In the various embodiments of the present disclosure, a script is exemplified as a drama script, but the scope of the scripts which may be used is not limited to dramas, and the present disclosure may be applied to scripts utilized for movies or plays. Namely, in the various embodiments of the present disclosure, the content may correspond not only to dramas, but to movies, plays, animations, etc. as well.

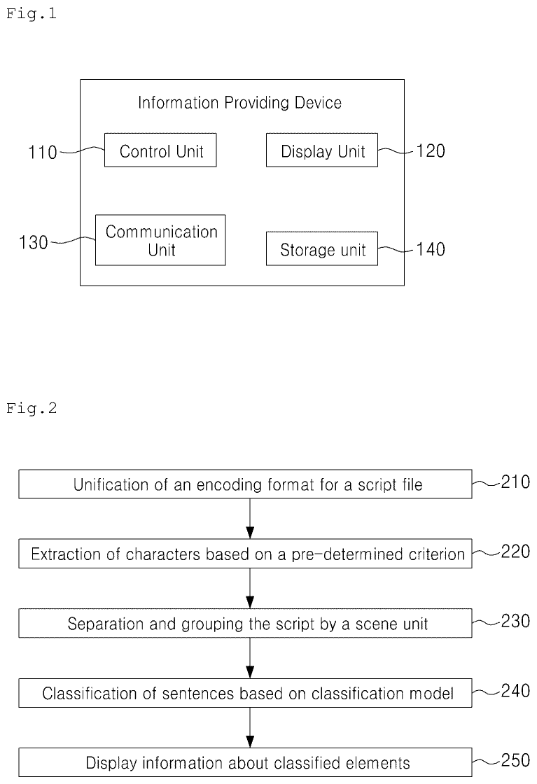

FIG. 1 illustrates a configuration of the information provision device that provides content production information according to one embodiment of the present disclosure.

The information provision device includes a control unit (110), a display unit (120), a communication unit (130), and a storage unit (140).

The control unit (110) performs the overall control functions of the information provision device, and may also control other units. The control unit (110) may be, for example, a processor (CPU or GPU) or an engine. In various embodiments of the present disclosure, the control unit (110) may be located in an external system (e.g., a server). The control unit (110) may perform various operations for the information provision device using programs and data stored in the storage unit (140).

The display unit (120), under the control of the control unit (110), displays various contents through a user interface and/or GUI stored in the storage unit (140). Here, the content displayed by the display unit (120) may include various text or image data (including various information), menu screens, etc. which includes data such as icons, list menus, and combo boxes. In addition, the display unit (120) may be a touch screen.

The display unit (120) may include a liquid crystal display (LCD), a thin film transistor-liquid crystal display (TFT LCD), an organic light-emitting diode (OLED) display, a flexible display, a 3D display, an e-ink display, etc., with the technology used in the display unit (120) not limited to the above examples.

The communication unit (130) may communicate with any internal component or at least one arbitrary external device through a wired/wireless communication network. Here, wireless communication technologies may include Wireless LAN (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), 5G mobile communication services, Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, Long-Range (LoRa), etc. Meanwhile, wired communication technologies may include Power Line Communication (PLC), USB communication, Ethernet, serial communication, optical/coaxial cables, etc. Further, the technology used in the communication unit (130) is not limited to the above examples.

The storage unit (140) stores programs and data according to various embodiments of the present disclosure. Namely, the storage unit (140) may store a number of application programs which can be executed by the information provision device, operation data, and commands. At least some of the application programs may be downloaded from an external device via wireless communication technology. In addition, at least some of the application programs may have been pre-installed in the information provision device.

In addition, the storage unit (140) may include at least one storage medium among Flash Memory Type, Hard Disk Type, Multimedia Card Micro Type, card type memory (e.g., SD or XD memory), magnetic memory, magnetic disk, optical disk, Random Access Memory (RAM), Static Random Access Memory (SRAM), Read-Only Memory (ROM), Electrically Erasable Programmable Read-Only Memory (EEPROM), and Programmable Read-Only Memory (PROM), with the technology used in the storage unit (140) not limited to the above examples.

In various embodiments of the present disclosure, the information provision device may not include at least some of the components of FIG. 1, and may also include additional components not shown in FIG. 1. For example, the information provision device may further include an input unit, and the input unit may receive document content through scanning. In another example, the information provision device may not include a separate communication unit.

FIG. 2 illustrates a method for processing a script file into a structured format according to one embodiment of the present disclosure.

In step (210), the encoding format of the script file is unified. For example, the drama script may be separated into episode units and saved as separate txt files. Then, each txt file can be taken as input, converted to UTF-8 encoding, and saved again as individual txt files.

In step (220), characters are extracted based on predetermined criteria. For example, the first portion of each sentence (e.g., the first 8 letters) can be extracted from every episode of the relevant drama. Then, extracted elements that are not names (e.g., verbs, adjectives) can be removed using a Korean morphological analyzer (e.g., Kiwi library), and the remaining elements can be extracted to create a list of characters ranked in descending order of frequency of appearance across all episodes.

In step (230), the script is separated and grouped into scene units. For example, the content of a script can be grouped into scene units by checking each sentence for RegExes used as scene delimiters (e.g., S #1, scene/1). In one embodiment of the present disclosure, scene number (scene_num) and/or location information for each scene can be extracted from sentences grouped into scene units.

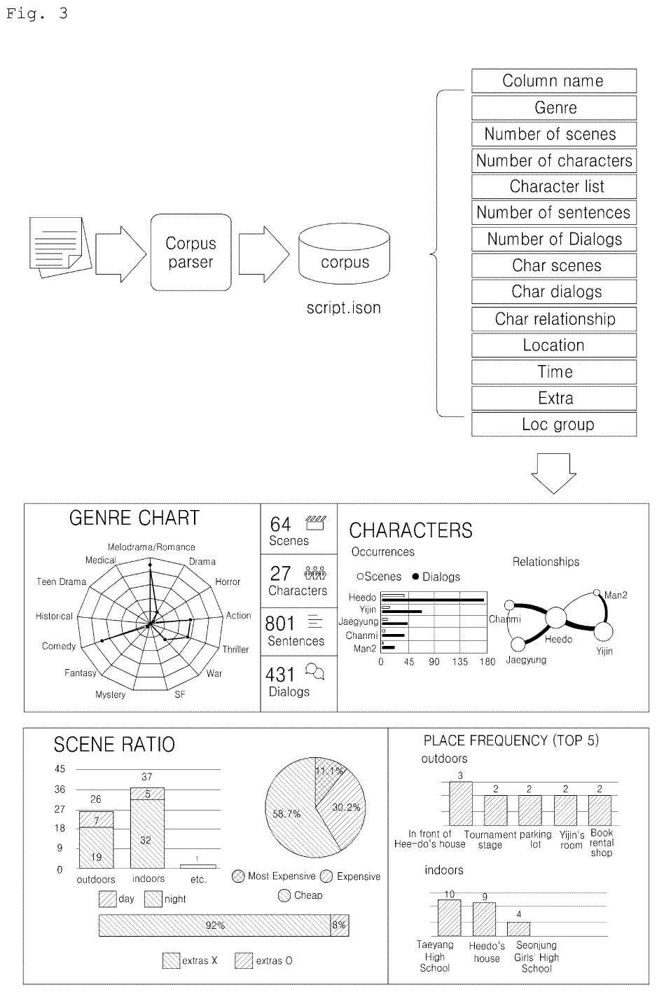

FIG. 3 illustrates a script structuring process and results screen according to one embodiment of the present disclosure.

In FIG. 3, an example of separating text into scene units from a given script text (script.txt) is illustrated.

In step (240), the sentences may be classified based on the narration/dialogue classification model. This step may be performed only on sentences that do not contain scene number and/or location information. In this step, each sentence can be classified under a binary classification model as either “narration” or “script-dialogue.” Alternatively, if configured to classify ‘stage directions within dialogue’ as “script-action,” the step (240) may be implemented such that each sentence is classified into one of three categories (narration/script-dialogue/script-action). Accordingly, each sentence can be classified as ‘narration’ or ‘script-dialog’ through the model that performs binary classification of narration/dialogue, and stage directions within dialogue can be automatically classified as ‘script-action’. Each classified sentence is stored in a labelled list format.

In addition to script-dialogue/narration, as shown in FIG. 3, characters, locations, times, actions, etc. within each scene may be classified and stored as a corpus (corpus data; script.json). This can be defined as structuring. In various embodiments of the present disclosure, locations, times, extras, genres, etc., that affect the cost for producing dramas and the like, can be defined as production cost-related elements. For example, night scenes, which generally require more lighting and staff, or scenes with many extras could lead to higher production costs, so information about this is provided to the user to be reflected in video production and budget estimates.

In step (250), information about the classified elements is displayed.

In the structured corpus, the desired items (Column Names) such as genre, number of scenes, number of characters, and character list, can be extracted and presented to the user through an intuitive GUI. In various embodiments of the present disclosure, the GUI may be interactive. For example, in the character relationship diagram in the upper right of FIG. 3, the user may click on a character and move the character around on the screen by dragging and dropping, and the lines connecting characters may also be drawn in real time to match the new user-designated position. As another example, for interfaces such as the scene ratio and genre chart, when the user hovers the mouse pointer over a bar, chart, or label, information about the relevant item is shown in a speech bubble (as a mouse hovering tip).

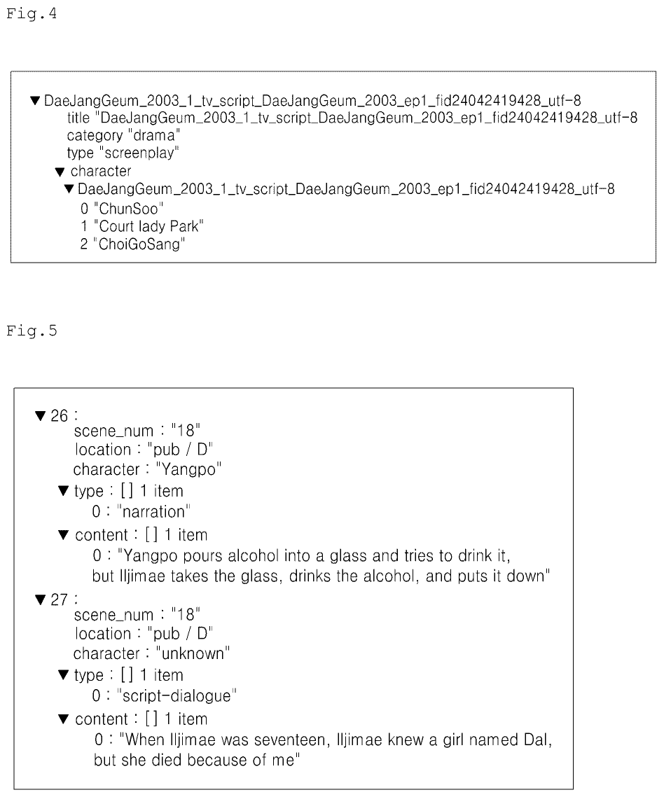

FIG. 4 displays a list of characters extracted from a script file according to one embodiment of the present disclosure.

In FIG. 4, information such as title, category, and type are also displayed above the character information. In the example displayed in FIG. 4, a specific file name is assigned as the title for version management purposes. However, the actual title of the content may also be used (e.g., DaeJangGeum). In FIG. 4, the type is defined as “screenplay,” with other options for type including logline, treatment, synopsis, scenario, proposal, etc. In the character section of FIG. 4, the title appears below the character heading line, and includes relevant information such as the content title, episode number, and file version.

FIG. 5 displays a narration/dialogue classification extracted from a script file according to one embodiment of the present disclosure.

In FIG. 5, it may be seen that “26” in the first line is the internal unit (division) number of the corpus, and in the second line, the “scene_num” for the text file is “18.” Since there are cases where script text may start in the middle of a scene without any metadata field or scene number, the scene number in the script and the corpus division/unit number may be different. “Location” refers to the location information, which usually appears along with the scene number, and “character” refers to the characters appearing in the scene. When the type is defined as “narration,” the narration content is shown, not the dialogue. For unit number 27, the script scene number and location are the same as unit 26, and an unknown character in the script is seen to speak dialogue (type=script-dialogue).

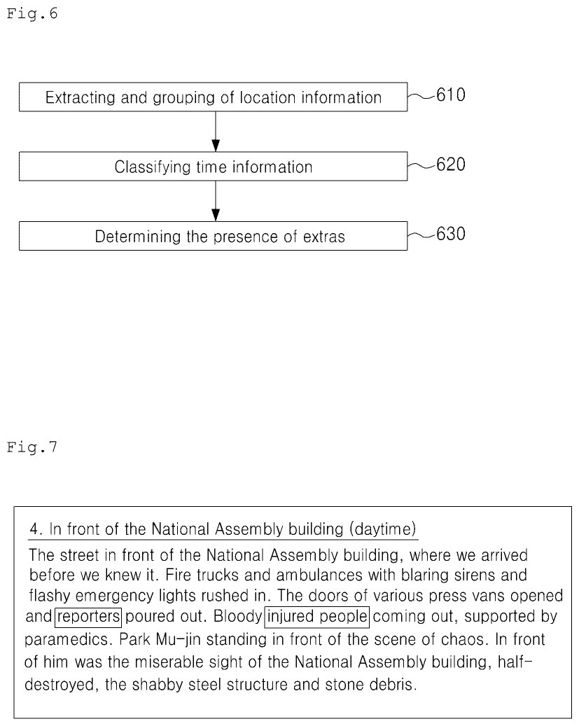

FIG. 6 illustrates a method for extracting and classifying factors related to production costs according to one embodiment of the present disclosure.

In step (610), the location information is extracted and grouped.

Separating and grouping the script by scene unit is exemplified in step (230) of FIG. 2, and the scene information extracted here may include information on the locations where the scenes are filmed. This information can be used to determine whether each scene is indoors or outdoors and group them accordingly. There may be cases where the scene location information includes information other than that which indicates a location, and in such cases, an “Other” can be added. For example, a reception room may be classified as “Indoors,” an area in front of the National Assembly as “Outdoors,” and the character Jiwoo's flashback as “Other.” A pre-trained (supervised learning) language model may be used to classify (determine) whether each scene is indoors/outdoors/other once it has labeled its training data.

After classifying the location of each scene, the locations may be grouped by measuring word similarity. For example, “outside the detention center,” “near the detention center,” and “entrance to the detention center” may all be grouped as “outside the detention center.” Then, the grouped locations may be shown to the user by being distinguished as indoors or outdoors according to predefined rules (for example, order of frequency). The classified location information can be further analyzed or processed to be displayed to the user as information such as outdoor locations that are relatively expensive to produce, indoor filming ratios that can reduce production costs, and/or scene frequency for each location.

In step (620), time information is classified.

After the script is separated and the sentences are grouped by scene, the extracted information can include information on time as well as location. The method for indicating time may vary depending on the drama (work), but it can be classified using a rule-based approach after establishing a list of various indication methods in advance. For example, time can be divided into Day and Night, where D/morning/daytime/AM/afternoon/lunch-time is classified (patterned) as “day” and N/E/evening/night/sunset/late-night/setting sun/early morning/dusk/dark may be classified as “night.” By combining these classifications throughout the script, information such as the ratio of day and night and number/frequency of scenes can be displayed.

In step (630), the presence of extras is determined.

For example, in step (240) of FIG. 2, using the information separated into narration/dialogue within the script, the presence of extras can be determined by targeting only the sentences classified as narration and extracting the plural forms (‘-s’) from each sentence. Then, using a named entity recognizer, it is possible to distinguish whether each extracted plural entity corresponds to a person or not. If an extracted plural entity corresponds to a person, it can be finally designated as an extra. Through this process, it becomes possible to determine whether multiple extras appear in each scene.

In various embodiments of the present disclosure, extraction, grouping, and/or classification tasks may be performed on other information in addition to location information, time information, and extra information. The extraction, grouping, and/or classification tasks may correspond to performing information analysis and processing using a supervised-learning-derived model, and tasks such as named entity recognition or morphological analysis, for instance, may also be used. Accordingly, if there is a request for items such as genre, number of scenes, number of characters, list of characters, number of sentences, number of lines of dialogue, character scenes, character dialogues, character relationships, locations (e.g. indoors, outdoors), times, extras, or location groupings, the information provision device may display information on the relevant items through the display unit.

FIG. 7 shows an embodiment of a dialogue in the script.

According to the embodiment in FIG. 7, the first line “In front of the National Assembly (Day)” can be classified as Location: Outdoors, Time: Day. In addition, in the narration sentence of FIG. 7, “reporters” and “injured people” may be identified and stored as extras.

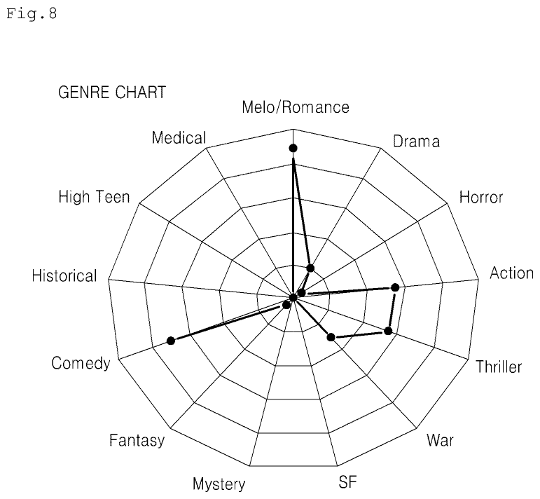

FIG. 8 illustrates an embodiment of the genre chart display.

The embodiment of FIG. 8 illustrates, using a graph, the degree of relevance an input script has with pre-classified genres. In this example, the graph shows that the highest degree of relevance for the input script is the melodrama/romance genre. Alternatives for the genre chart display could include only showing the most relevant genre, displaying the degree of relevance with each genre as a numerical value (e.g., 0.4 or 40%), or displaying only those genre(s) with a degree of relevance higher than a predetermined value (e.g., 0.5 or 50%).

To display genre information, genre model training can be performed. First, by labeling or refining genre data from collected scripts (text content), mapping to one or more predefined genres within a certain number of texts can be completed, and a genre model can be trained through supervised learning using this mapping. At this time, to avoid overfitting, a certain percentage (x %) of the data can be set aside as validation data to select the model with the best performance, or n-fold cross-validation can be used to select the model. Also, the final model can be trained in the form of an ensemble model rather than a single model. This type of model is in the form of assigning a binary label to one model, and learning one model (including ensemble) for each of n genres; a value between 0 and 1 before the binary label result can be used to indicate the genre degree. For example, a script scored as 0.43 thriller can be displayed as 43% thriller even though it is 0 in the binary label and therefore not a thriller. There are many such inference models used in machine learning classifier methodology, such as linear regressor, softmax function, generalized linear models, logistic regressor, Naive Bayes, Decision Tree, Logistic Regression, K-Nearest Neighbor, random forest, Artificial Neural Networks/Deep Learning, and Support Vector Machine.

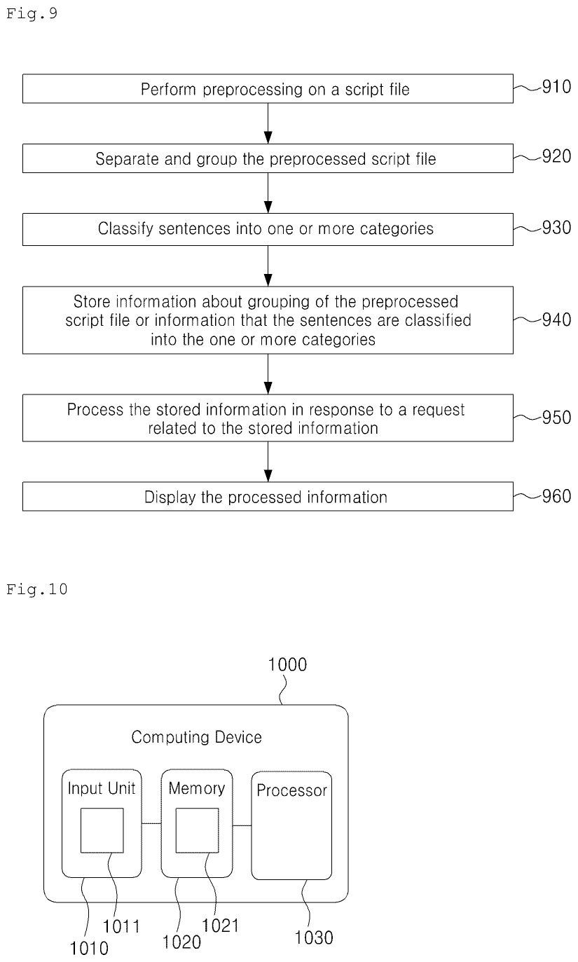

FIG. 9 illustrates a method by which the information provision device provides content production information according to one embodiment of the present disclosure.

In step (910), the control unit performs preprocessing on a script file. The preprocessing may include changing the encoding format for the script file to a predetermined format (e.g., UTF-8), and may include changing the script file extension to json.

In step (920), the control unit separates and groups the contents of the preprocessed script file. Here, grouping means binding separated script t sub-files which satisfy certain conditions together into groups of script sub-files. Separately from step (920), the control unit may also extract characters from the preprocessed script file and sort them according to predetermined criteria (e.g., order of frequency), and may also control the storage unit to store information about the sorted characters.

In step (930), the control unit classifies, for each separated script file, sentences which meet predetermined condition into one or more categories. The predetermined condition may be that the sentence does not include specific information, where the specific information may correspond to scene number or location information. Further, the above-described one or more categories may include at least one of location, time, extras, and genre. The above-described classification may be performed based on an AI model that has undergone pre-training. The AI model may be one that has been trained based on machine learning or deep learning.

In step (940), the control unit controls the storage unit to store information related to the grouping of the preprocessed script file or information on the classification of sentences into one or more categories.

In step (950), the control unit processes the stored information in response to requests related to the stored information. Processing of the stored information may include creating frequency or ratio information for at least some of the items of the stored information, and may include creating recommendation information. For example, in response to requests related to production cost optimization, information on scenes that correspond to the same time zone, same location, and same actor(s) may be generated. Filming these scenes consecutively (even if they are not aired in sequence) can help optimize (reduce) production costs. The processing of the stored information may also include modifying or specifying the categories of the stored information. For example, processed information categories may include one or more of genre elements, relationships among characters, location classifications, major locations by indoor/outdoor classification, time classifications, presence/absence of extras, number of scenes, number of characters, or number of dialogues.

In step (960), the control unit controls the display unit to display the processed information. The control unit may control the display unit to change at least a portion of the displayed information or display new information in response to inputs for displayed information.

FIG. 10 illustrates a configuration of a system for providing information regarding content production according to one embodiment of the present disclosure.

Referring to FIG. 10, the information provision system includes a computing device (1000), and the computing device (1000) includes an input unit (1010), memory (1020), and a processor (1030).

The memory (1020) may store data (1011) from the input unit (1010), etc., and the data (1011) may also be stored in a separate device (e.g., a large-capacity storage server). The memory (1020) may be volatile memory (e.g., SRAM, DRAM) or nonvolatile memory (e.g., NAND Flash). The data (1011) may correspond to a script.

The processor (1030) may create a classification model (1021) using training data and store it in the memory (1020). When a classification task for new data is requested, the processor (1030) may perform the relevant task through the classification model (1021) in the memory (1020), and output the result.

The information provision system according to other embodiments of the present disclosure may further include the computing device (1000) including the memory (1020) and the processor (1030), as well as a server or servers including memory and a processor. The computing device (1000) and the server(s) may be connected by wire or wirelessly through a network. In one embodiment of the present disclosure, the server memory may store a classification model (1021) that has undergone artificial neural network-based training.

In one embodiment of the present disclosure, the processor (1030) of the computing device (1000) may transmit the data (1011) and a request (query) stored in the memory (1020) to the server. The server processor may perform a classification task on specified target data (1011) by executing the classification model (1021) stored in the memory that has undergone artificial neural network-based training on the transmitted data (1011), and the result may be transmitted to the computing device (1000).

In various embodiments of the present disclosure, the computing device may include various devices, such as a smartphone, tablet, laptop, desktop, server, or client. The computing device may be a single stand-alone device, or may include various computing devices which run in a distributed environment composed of multiple computing devices which cooperate with each other through a communication network.

Meanwhile, the computing device may be a quantum computing device, which performs computations using qubits rather than bits, as opposed to a classical computing device. A qubit may have a state where 0 and 1 are in superposition at the same time, and if there are M number of qubits, a state of 2\hat{ }M may be expressed at the same time.

The AI model described in the present embodiments may be a current or future machine learning model, such as a model that has undergone algorithm-based machine learning and operates on the aforementioned computing device, or a model that has undergone artificial neural network-based training. The AI model may be an ensemble model that solves problems by learning and combining multiple models as opposed to using only one learned model. Ensemble models may prevent overfitting and improve generalization performance by combining various models which have undergone learning individually, and may be useful for improving performance when individual model performance is not secured.

An artificial neural network is a machine learning algorithm which analyzes and learns using complex data based on a large number of artificial neurons connected to each other, similar in principle to the human brain. The artificial neural network may be any artificial neural network, such as a Multi-Layer Perceptron (MLP), the most basic artificial neural network structure composed of an input layer, a hidden layer, and an output layer; a Convolutional Neural Network (CNN), which performs convolution computations in order to extract image features and reduces dimensions through pooling computations; or a Recurrent Neural Network (RNN), an artificial neural network structure which is used to process ordered data. The artificial neural network may be modified in various ways depending on data complexity and diversity.

In various embodiments of the present disclosure, an algorithm-based machine learning model and a model having undergone artificial neural network-based learning may be complementarily used. For example, the algorithm-based machine learning model may make use of the results from the artificial neural network-based learning model, or the artificial neural network-based learning model may make use of the results from the algorithm-based machine learning model. An ensemble model of the algorithm-based machine learning and artificial neural network-based learning models may also be used.

The present embodiments described above may be implemented through various means. For example, they may be implemented by hardware, firmware, software, or a combination thereof.

In cases where an embodiment is implemented by hardware, the method for generating an image for AI learning is created according to the present embodiments may be implemented by one or more of ASICS (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, or microprocessors.

AI learning according to various embodiments of the present disclosure may be implemented using an AI semiconductor device which implements deep neural network neurons and synapses as semiconductor elements. At this time, the semiconductor elements may be currently used elements such as SRAM, DRAM, or NAND, or may be next-generation semiconductor elements such as RRAM, STT MRAM, or PRAM, or may be a combination thereof.

When implementing AI learning according to the embodiments using a semiconductor device, the results (weights) of learning for a deep learning model using software may be transcribed to synapse-mimicking elements disposed in an array, or learning may be performed on the semiconductor device.

In addition, terms such as “system,” “processor,” “controller,” “component,” “module,” “interface,” “model,” “unit,” etc., as used herein may generally refer to computer-related entity hardware, such as hardware, software, a combination of hardware and software, or software in execution. For example, the aforementioned components may be a process driven by a processor, a processor, a controller, a control processor, an object, a thread of execution, a program, and/or a computer, but are not limited to these. To illustrate, an application running on a controller or processor and the controller or processor thereof may all be considered components. One or more components may be within the process and/or thread of execution, and the components may be located on a single device (e.g., a system, a computing device) or may be distributed across two or more devices.

In one embodiment of the present disclosure, a computer program which is stored on a computer recording medium may be used to execute the above-described method for providing content production information. Additionally, a computer-readable recording medium storing a program for implementing this method may be used. The program may be installed and executed by the computer, enabling the execution of the aforementioned steps.

For a computer to be able to read a program recorded on a recording medium and execute the program's functions, the program may include codes written in a computer language such as Python, C, C++, JAVA, or machine language, readable by the computer's processor (CPU) via an interface.

Such code may include function codes, related to the previously mentioned functions, and control codes, related to the execution of the function codes.

Additionally, such codes may further include memory reference codes related to the location, in the internal or external memory of a computer, of additional information or media required for the computer processor to execute the above-described functions.

In cases where the computer processor needs to communicate with, for example, a remotely located computer or server to execute the above-described functions, the codes may further include communication codes related to how the computer processor performs said communication using the computer's communication module, and what information or media should be sent and received during the communication.

A recording medium readable by a computer containing the program described above may include, for example, ROM, RAM, a CD-ROM, magnetic tape, a floppy disk, or an optical media storage device, and may also include mediums which implement carrier waves (e.g., Internet transmissions).

Additionally, since a recording medium by a computer may be distributed across a network-connected system, code that can be read and executed by the computer in a distributed manner may be stored and processed.

Furthermore, the functional program for implementing the present disclosure, and the codes and code segments related thereto, taking into consideration that the system environment is a computer-readable and computer-executable recording medium, may be easily inferred or altered by programmers in the technical field to which the present disclosure belongs.

The above detailed description of the present disclosure is for illustrative purposes, and those skilled in the technical field to which the present disclosure belongs will recognize that the present disclosure may be easily modified into other specific forms without changing technical ideas or essential features of the present disclosure. Therefore, it should be understood that the embodiments described above are exemplary in all respects, and not limiting. For example, each component which is described as a single type may be implemented in a distributed method, and likewise, components which are described as distributed may also be implemented in a combined form.

The scope of the present disclosure is defined by the claims to be described later, beyond the detailed description provided here. All changes or modifications derived from the meaning, scope, and equivalent concepts of the claims should be interpreted as included within the scope of this disclosure.

What is claimed is:

1. A method for providing information regarding content production, the method comprising:
performing preprocessing on a script file;
separating and grouping the contents of the preprocessed script file;
classifying, for each separated script file, sentences which meet a predetermined condition into one or more categories;
storing information related to the grouping of the preprocessed script file or information on the classification of sentences into one or more categories;
processing the stored information in response to requests related to the stored information; and
displaying the processed information.

2. The method of claim 1, wherein the classifying is performed based on a pre-trained AI model.

3. The method of claim 1, wherein the preprocessing comprises changing the encoding format of the script file to a predetermined format.

4. The method of claim 1, further comprising:
extracting characters from the preprocessed script file and sorting the characters according to predetermined criteria; and
storing information about the sorted characters.

5. The method of claim 1, wherein the predetermined condition is that the sentence does not include scene number or location information.

6. The method of claim 1, wherein the one or more categories includes at least one of location, time, extras, and genre.

7. The method of claim 1, wherein the processing of the stored information comprises generating frequency or ratio information for at least some of the items of the stored information.

8. The method of claim 1, further comprising:
changing at least a portion of the displayed information or displaying new information in response to inputs for displayed information.

9. A device for providing information regarding content production, comprising:
a control unit configured to perform preprocessing on a script file, separate and group the contents of the preprocessed script file, classify, for each separated script file, sentences which meet predetermined condition into one or more categories, and process the stored information in response to requests related to the stored information;
a storage unit configured to store information related to the grouping of the preprocessed script file or information on the classification of sentences into one or more categories; and
a display unit configured to display the processed information.

10. The device of claim 9, wherein the classifying is performed based on a pre-trained AI model.

11. The device of claim 9, wherein the preprocessing comprises changing the encoding format of the script file to a predetermined format.

12. The device of claim 9, wherein the control unit is further configured to extract characters from the preprocessed script file, sort the characters according to predetermined criteria, and store information about the sorted characters.

13. The method of claim 9, wherein the predetermined condition is that the sentence does not include scene number or location information.

14. The device of claim 9, wherein the one or more categories includes at least one of location, time, extras, and genre.

15. The device of claim 9, wherein the processing of the stored information comprises generating frequency or ratio information for at least some of the items of the stored information.

16. The device of claim 9, wherein the display unit is further configured to change at least a portion of the displayed information or display new information in response to inputs for displayed information.

17. A computer-readable storage medium storing a program for providing information regarding content production, wherein the program causes a computer to execute the following operations:
performing preprocessing on a script file;
separating and grouping the contents of the preprocessed script file;
classifying, for each separated script file, sentences which meet predetermined condition into one or more categories;
storing information related to the grouping of the preprocessed script file or information on the classification of sentences into one or more categories;
processing the stored information in response to requests related to the stored information; and
displaying the processed information.
